(19) United States
(12) Patent Application Publication
(10) Pub. No.: US 2026/0227024 A1
(43) Pub. Date: Aug. 6, 2026

(54) QUICK RELEASE MOUNTING ASSEMBLY AND BRACKET

(71) Applicant: Shenzhen Anymore Technology Co., Ltd., Shenzhen (CN)

(72) Inventors: TAORONG LIU, Shenzhen (CN); SHI-XIAN YE, Shenzhen (CN)

(21) Appl. No.: 19/630,832

(22) Filed: Mar. 27, 2026

(30) Foreign Application Priority Data
Dec. 31, 2025 (CN) 202522843289.X

(51) Int. Cl. F16M 11/04; F16M 13/02; G03B 17/56

(52) U.S. Cl. CPC F16M 11/041; F16M 13/02; G03B 17/561; F16M 2200/02

(57) ABSTRACT

A quick release mounting assembly for a camera includes a base, a mounting member, and a lock member. The base has a bearing surface and a periphery limit that together define an opening. The mounting member is insertable into the opening and configured for attachment to a camera. The lock member is mounted on the base and movable relative to the base between a locking position and an unlocking position. When moving toward the locking position, the lock member pushes the mounting member against the periphery limit and presses it against the bearing surface, thereby positioning the mounting member and the attached camera. When moving toward the unlocking position, the lock member releases the mounting member, allowing it to be detached from the opening. The assembly enables rapid attachment and detachment of the camera to a bracket, facilitating efficient switching between fixed-position and mobile tracking photography modes.

### FIELD

The disclosure herein generally relates to camera attachment and detachment with bracket, and more particularly relates to a quick release mounting assembly and a bracket.

### BACKGROUND

Cameras are commonly used in two primary working modes: fixed-position photography and mobile tracking photography. In fixed-position photography, a camera is typically mounted to a bracket, such as a tripod, to maintain a stable position. However, switching between fixed-position photography and mobile tracking photography requires frequent attachment and detachment of the camera from the bracket. In conventional systems, such attachment and detachment often involve cumbersome operations, resulting in low efficiency and reduced convenience for the user.

### BRIEF DESCRIPTION OF THE DRAWINGS

FIG. 1 is a perspective view of a quick release mounting assembly according to the present disclosure, wherein a mounting member is mounted on a base.

FIG. 2 is a perspective view of the quick release mounting assembly of FIG. 1 when the mounting member is separated from the base.

FIG. 3 is an exploded view of the quick release mounting assembly of FIG. 1.

FIG. 4 is a cross-sectional view of the quick release mounting assembly of FIG. 2, taken along line B-B, wherein the mounting member is removed.

FIG. 5 is a cross-sectional view of the quick release mounting assembly of FIG. 1, taken along line A-A, wherein a locking member is located at a locking position.

FIG. 6 is a cross-sectional view of the quick release mounting assembly of FIG. 5 when the locking member is located at an unlocking position.

FIG. 7 is an enlarged view of portion C in FIG. 5.

FIG. 8 is a perspective view of a quick release mounting assembly according to another embodiment of the present application, wherein a mounting member is mounted on a base.

FIG. 9 is an exploded perspective view of the quick release mounting assembly of FIG. 8.

FIG. 10 is a cross-sectional view of the quick release mounting assembly of FIG. 8 taken along line D-D, wherein a locking member is located at a locking position.

FIG. 11 is a perspective view of a bracket according to an embodiment of the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, baffle structures, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “comprising” means “including, but not necessarily limited to;” it specifically indicates open-ended inclusion or membership in a so-described combination, group, series, and the like.

Without a given definition otherwise, all terms used have the same meaning as commonly understood by those skilled in the art. The terms used herein in the description of the present disclosure are for the purpose of describing specific embodiments only, and are not intended to limit the present disclosure.

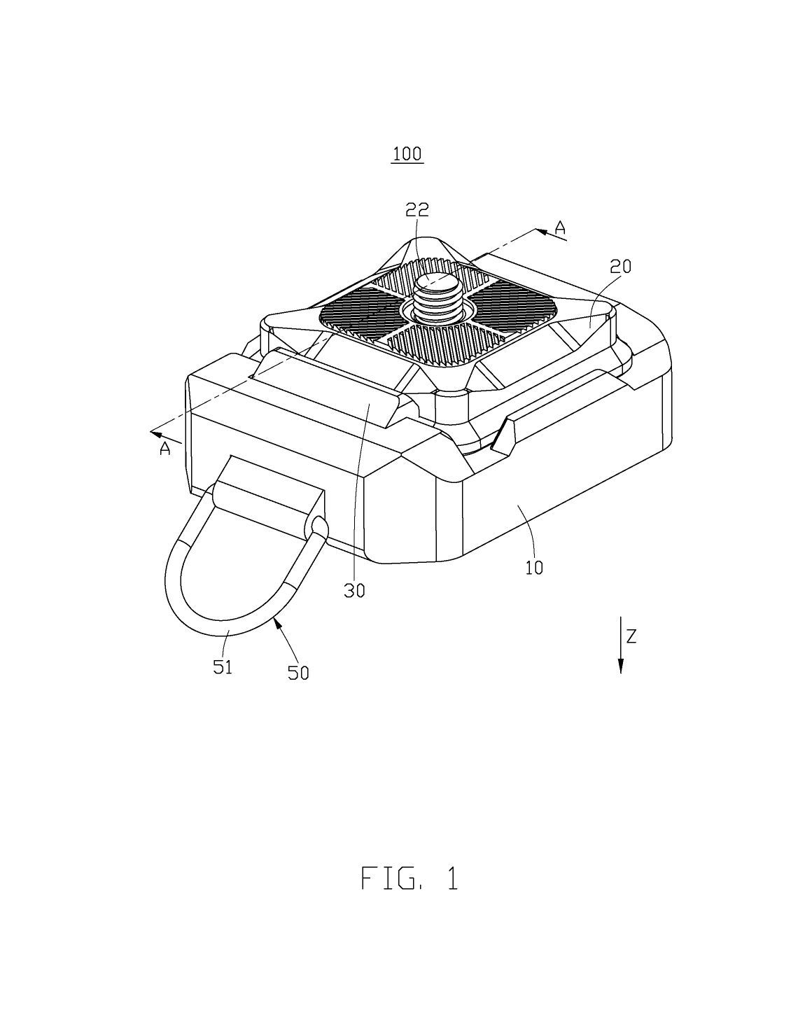

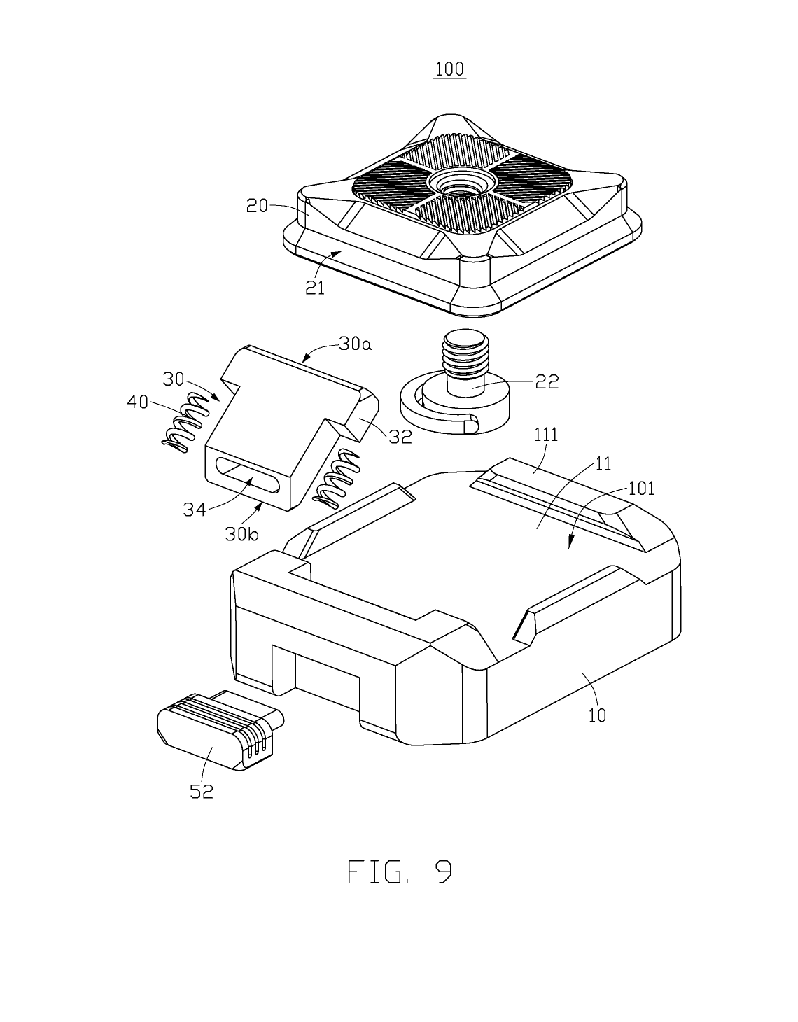

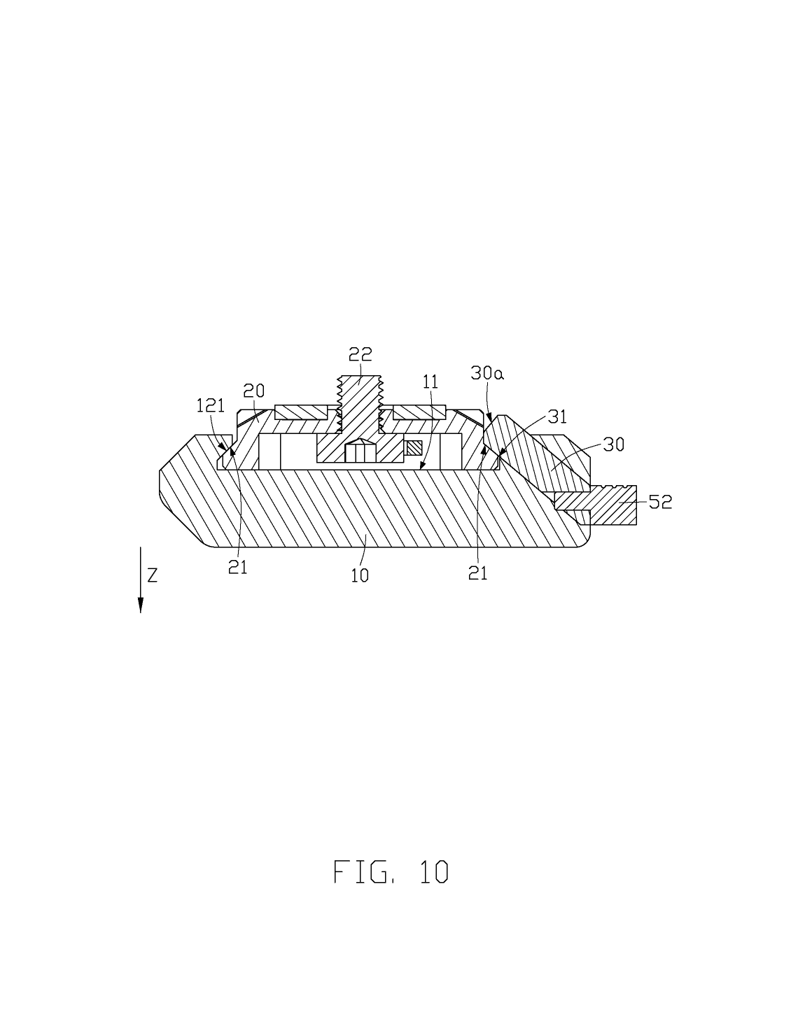

Please refer to FIG. 1 to FIG. 10, the present application provides a quick release mounting assembly 100 that can be applied to a bracket 200 for quick attachment and detachment of a camera.

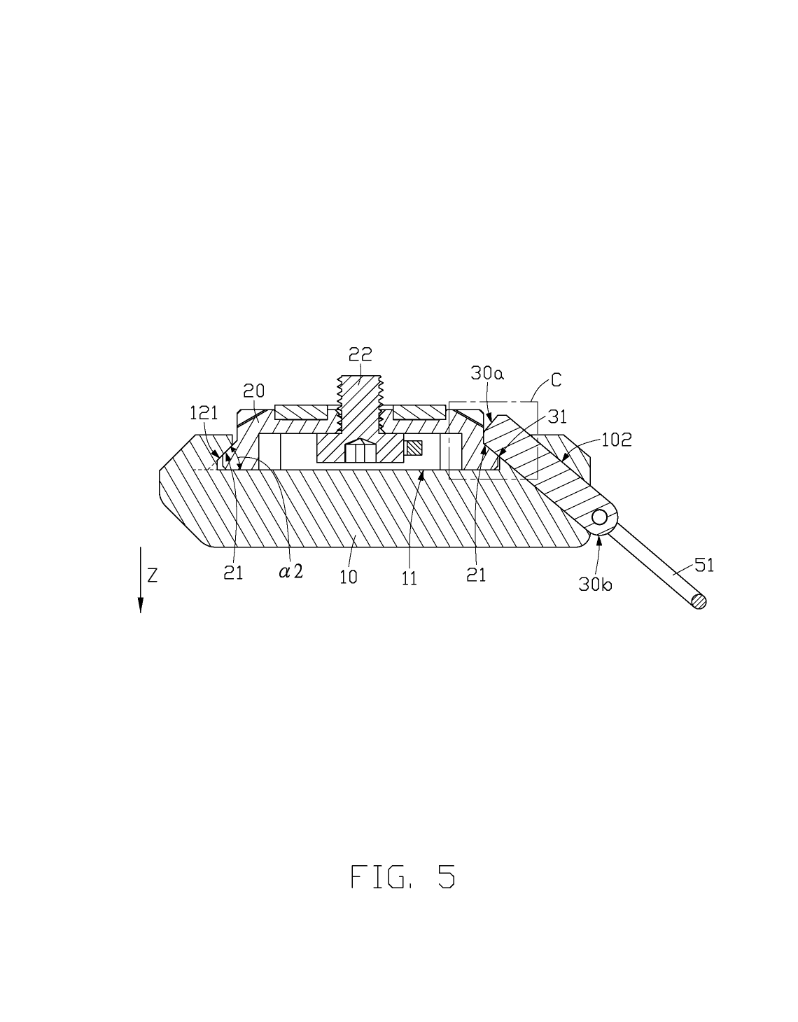

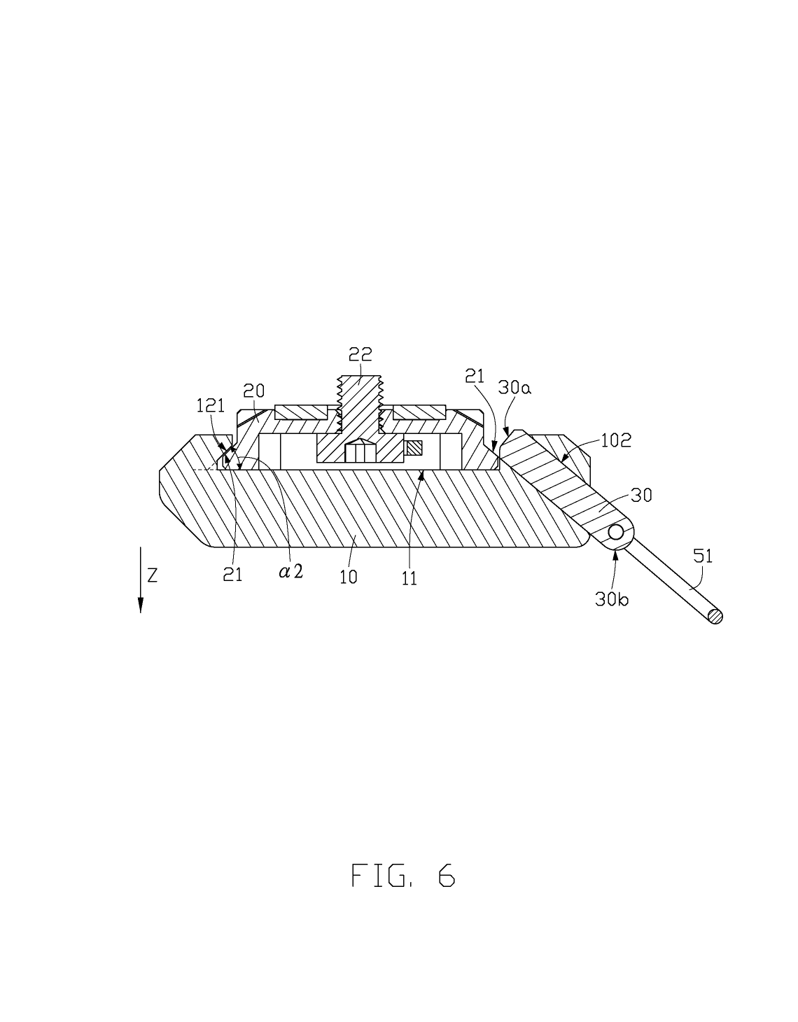

Please refer to FIG. 1 to FIG. 4. The quick release mounting assembly 100 includes a base 10, a mounting member 20, and a lock member 30. The base 10 is fixed to the bracket 200 and provided with an opening 101. The mounting member 20 is insertable into the opening 101. The lock member 30 is mounted on the base 10 and is movable relative to the base 10 between a locking position and an unlocking position. Please refer to FIG. 5, when the lock member 30 is located at the locking position, the lock member 30 positions the mounting member 20 within the opening 101. Please refer to FIG. 6, when the lock member 30 is located at the unlocking position, the lock member 30 releases the mounting member 20, so that the mounting member 20 can be taken out from the opening 101.

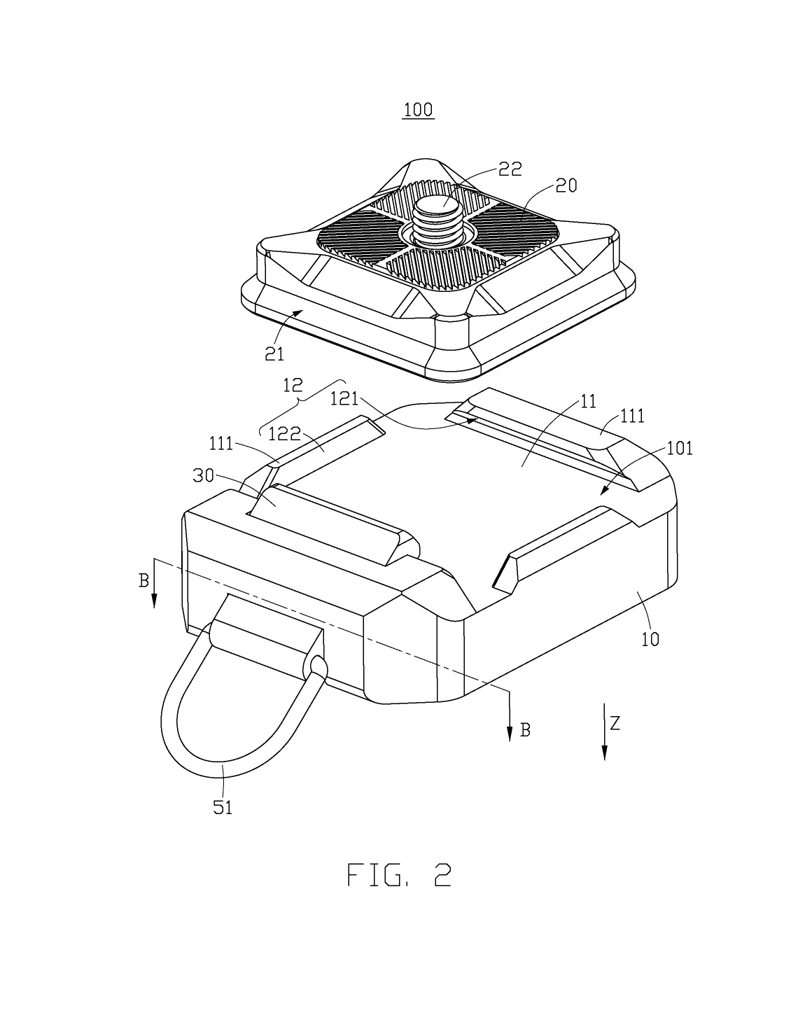

Please refer to FIG. 2 to FIG. 6. The base 10 has a bearing surface 11 and a periphery limit 12, and the opening 101 is jointly enclosed by the bearing surface 11 and a periphery limit 12. When the lock member 30 is located at the locking position, the lock member 30 pushes the mounting member 20 against the periphery limit 12 and presses the mounting member 20 against the bearing surface 11. The lock member 30 locks the mounting member 20 within the opening 101 through the pushing and pressing actions, thereby fixing the mounting member 20 to the base 10.

The mounting member 20 is mounted on bottom of the camera, so that the lock member 30 can fix the camera to the base 10 by locking the mounting member 20. Similarly, by taking out the mounting member 20 from the opening 101, the camera can be separated from the base 10. The camera can also be any other photography equipment such as mobile phones and tablets.

When the quick release mounting assembly 100 is used, moving the lock member 30 between the locking position and the unlocking position by users enables the base 10 to quickly clamp the camera and allows quick detachment of the camera from the base 10. The attachment and detachment actions are simple to users, improving the attachment/detachment efficiency.

After the base 10 clamps the camera, the position of the camera is fixed, so the camera can perform in fixed-position photography mode. During fixed-position photography, there may be situations requiring switching to mobile tracking shooting mode, in these situations, by driving the lock member 30 to move to the unlocking position, the photographer can hold the camera and move it upward to drive the mounting member 20 out of the opening 101, thereby completing quick detachment of the camera from the base 10, so the photographer can hold the camera by hand for mobile tracking shooting.

Please refer to FIG. 2 to FIG. 4. In some embodiments, the base 10 has a plurality of limit bumps 111 on the bearing surface 11, and the opening 101 is jointly enclosed by the bearing surface 11 and a plurality of limit bumps 111. The limit bumps 111 extend along the edge of the bearing surface 11, and the periphery limit 12 is formed on the limit bumps 111. Each two adjacent limit bumps 111 are spaced apart to form a gap, allowing the photographer to observe the locking state of the mounting member 20 through the gap.

In some embodiments, the quick release mounting assembly 100 further includes an elastic member 40. The elastic member 40 connects the base 10 and the lock member 30 and provides elastic force to urge the lock member 30 toward the locking position. For example, the elastic member 40 can be a spring or an elastic sheet.

After the mounting member 20 is inserted into the opening 101, the lock member 30 can automatically lock the mounting member 20 within the opening 101 under the force of the elastic force, realizing a quick self-locking function and improving the operational convenience of the quick release mounting assembly 100. The elastic member 40 provides continuous elastic force to the lock member 30, ensuring that the lock member 30 remains in the locking position without external force intervention, preventing accidental loosening of the mounting member 20, and improving the working reliability of the quick release mounting assembly 100.

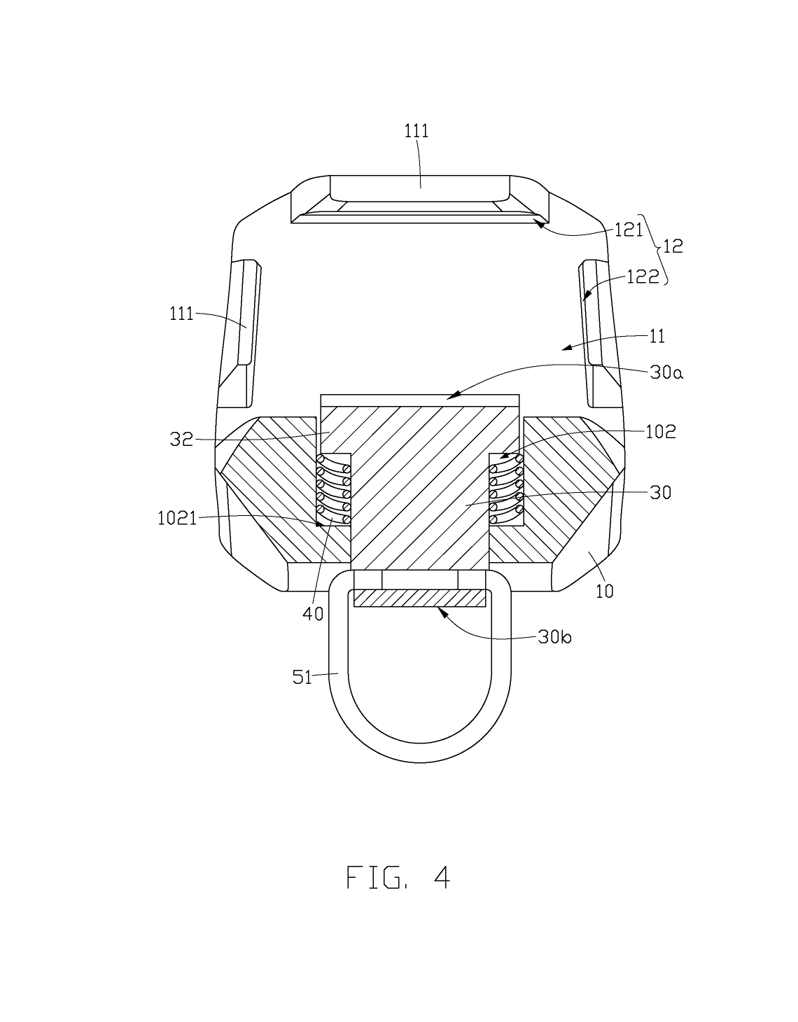

Please refer to FIG. 4 to FIG. 6. In some embodiments, the bearing surface 11 is provided with a slide groove 102 penetrating the base 10. The lock member 30 is slidably mounted in the slide groove 102. The slide groove 102 can guide the movement of the lock member 30, ensuring stable switching of the lock member 30 between the locking position and the unlocking position, reducing the risk of deviation or jamming of the lock member 30, and improving the smoothness of movement of the lock member 30.

Please refer to FIG. 4. A supporting surface 1021 is provided in the slide groove 102. The lock member 30 includes a first end 30a and a second end 30b. A protrusion 32 extends from a side surface of the first end 30a. The protrusion 32 and the supporting surface 1021 respectively abut opposite ends of the elastic member 40, facilitating installation of the elastic member 40 and movement of the lock member 30 in the slide groove 102.

Please refer to FIG. 5 and FIG. 6. When the lock member 30 is located at the unlocking position, the first end 30a exits the opening 101, and the second end 30b extends out of the slide groove 102 to protrude from the base 10, and the elastic member 40 is elastically compressed. The rebound of the elastic member 40 can move the lock member 30 from the unlocking position to the locking position. When the lock member 30 is located at the locking position, the first end 30a extends out of the bearing surface 11 to enter the opening 101 and push the mounting member 20 to the periphery limit 12.

Please refer to FIG. 4. A protrusion 32 extends from each of the two width sides of the lock member 30. The quick release mounting assembly 100 includes two elastic members 40. Each protrusion 32 abuts one elastic member 40, so that the lock member 30 receives balanced elastic force from both sides during movement, which is beneficial for smooth movement of the lock member 30.

Please refer to FIG. 1 to FIG. 6 and FIG. 8 to FIG. 10. In some embodiments, the quick release mounting assembly 100 includes an operating member 50, and the operating member 50 is connected to the second end 30b and is used for being held by the photographer to pull the lock member 30 toward the unlocking position. The photographer can pull the operating member 50 with one hand to drive the lock member 30 toward the unlocking position, thereby quickly releasing the mounting member 20.

When the lock member 30 is located at the locking position, the operating member 50 abuts against one side of the base 10, so that the base 10 restricts the movement stroke of the lock member 30 in the slide groove 102 by preventing the operating member 50 from entering the slide groove 102, thereby preventing the second end 30b of the lock member 30 from excessively extending into the slide groove 102, to ensure that the operating member 50 can always be available to the photographer.

The maximum stroke range of the lock member 30 moving back and forth in the slide groove 102 is limited, because the supporting surface 1021 blocks the protrusion 32 from moving downward out of the slide groove 102, and the base 10 blocks the operating member 50 from entering the slide groove 102 upward, thereby preventing the lock member 30 from excessively extending or retracting and disengaging from the slide groove 102, allowing the lock member 30 to repeatedly lock the mounting member 20, and improving the reliability of the quick release mounting assembly 100.

Please refer to FIG. 5 to FIG. 7. In some embodiments, the lock member 30 is provided with a stop surface 31, and the stop surface 31 is inclined relative to the bearing surface 11. The stop surface 31 and the bearing surface 11 form an acute angle α1. The stop surface 31 faces toward the opening 101. When the lock member 30 moves toward the locking position, the first end 30a pushes the mounting member 20 toward the periphery limit 12, and the stop surface 31 applies a locking force perpendicular to the stop surface 31 to the mounting member 20. The vertical component of the locking force presses the mounting member 20 toward the bearing surface 11 to prevent the mounting member 20 from exiting the opening 101 in a direction opposite to its insertion direction Z.

When the lock member 30 is located at the locking position, the lock member 30 pushes the mounting member 20 to the periphery limit 12 via the first end 30a and presses the mounting member 20 against the bearing surface 11 via the stop surface 31. The bearing surface 11 is arranged horizontally, the lock member 30 achieves bidirectional locking (in the horizontal direction and the vertical direction) of the mounting member 20 in two perpendicular directions through the first end 30a and the stop surface 31, thereby enhancing the locking strength of the lock member 30 on the mounting member 20.

In some embodiments, the periphery limit 12 includes an inclined surface 121. The inclined surface 121 is inclined relative to the bearing surface 11, and both the inclined surface 121 and the stop surface 31 face toward the inside of the opening 101. The inclined surface 121 and the bearing surface 11 form an acute angle α2. When the lock member 30 moves toward the locking position, the mounting member 20 abuts the inclined surface 121 under the push of the lock member 30. The inclined surface 121 is provided on one limit bump 111 opposite to the lock member 30. When the lock member 30 is located at the locking position, the limit bump 111 and the lock member 30 jointly clamp opposite sides of the mounting member 20 to position the mounting member 20 in the horizontal direction. The inclined surface 121 and the stop surface 31 generate vertical components of force on the mounting member 20 to press it against the bearing surface 11, thereby stopping the mounting member 20 from exiting the opening 101 in the direction opposite to the insertion direction Z. Therefore, the limit bump 111 having the inclined surface 121 can achieve bidirectional constraint (horizontal direction and vertical direction) in two perpendicular directions on the mounting member 20, thereby improving the stability of the locked mounting member 20.

The limit bump 111 and the lock member 30 can form bidirectional constraints in the horizontal and vertical directions on the mounting member 20 to lock the mounting member 20 in the opening 101, preventing the mounting member 20 from shaking or exiting the opening 101, improving the stability of the locked mounting member 20. The insertion direction Z of the mounting member 20 is parallel to the normal direction of the bearing surface 11, and the direction opposite to the insertion direction Z refers to the direction opposite to the arrow shown in FIG. 5.

Please refer to FIG. 2 to FIG. 4. In some embodiments, the periphery limit 12 includes two vertical surfaces 122. The two vertical surfaces 122 are oppositely arranged and located on opposite sides of the inclined surface 121 to constrain lateral displacement of the mounting member 20 within the opening 101. The two vertical surfaces 122 are respectively provided on opposite faces of two limit bumps 111, so that the two vertical surfaces 122 form a guide channel. The mounting member 20 can be smoothly inserted into the opening 101 along the guide channel, and when the lock member 30 is located at the unlocking position, the mounting member 20 can be smoothly vertically withdrawn from the opening 101 along the guide channel, thereby improving the smoothness and efficiency of attachment/detachment of the mounting member 20.

Please refer to FIG. 5 to FIG. 7. In some embodiments, the mounting member 20 is provided with a mating surface 21. The mating surface 21 is used for abutting the stop surface 31 so as to receive a force directed toward the bearing surface 11 under the action of the stop surface 31. The mating surface 21 is inclined relative to the bearing surface 11 to obliquely fit the stop surface 31.

The mating surface 21 and the bearing surface 11 form an acute angle β, and α1<β. During the movement of the lock member 30 toward the locking position, the angle difference causes the stop surface 31 to gradually approach the mating surface 21 and continuously increase the locking force applied to the mating surface 21 as the movement continues, until the lock member 30 reaches the locking position, at which point the lock member 30 firmly restricts the mounting member 20 within the opening 101 via the stop surface 31.

If β≤α1, the stop surface 31 would be unable to effectively contact or press the mating surface 21, causing the locking function of the lock member 30 on the mounting member 20 to fail. Therefore, the angle difference design of α1<β improves the compensation capability for the fitting gap between the opening 101 and the mounting member 20, ensures the oblique pressing effect of the stop surface 31 on the mating surface 21, and improves the reliability of locking and the stability after locking of the mounting member 20.

In some embodiments, opposite sides of the mounting member 20 are both provided with mating surfaces 21 inclined relative to the bearing surface 11, so that the inclined surface 121 and the stop surface 31 each abuts one mating surface 21, ensuring the oblique pressing effect of the inclined surface 121 on the mounting member 20. When the lock member 30 is located at the locking position, the stop surface 31 and the inclined surface 121 form a symmetrically distributed oblique pressing structure on the mounting member 20, avoiding unilateral offset of the mounting member 20 and enhancing the fitting stability between the mounting member 20 and the bearing surface 11.

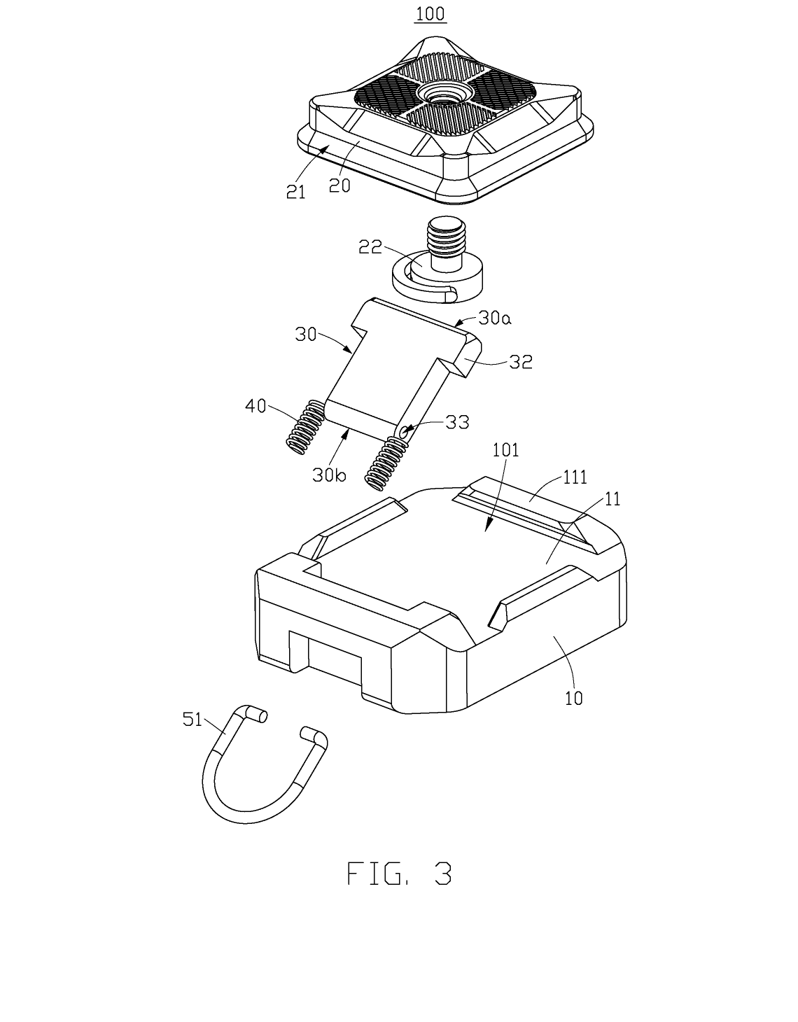

Please refer to FIG. 2 and FIG. 3. The mounting member 20 has four side surfaces, and all four side surfaces of the mounting member 20 are provided with mating surfaces 21 inclined relative to the bearing surface 11. The four side surfaces of the mounting member 20 have the same side length, forming a centrally symmetric structure. Therefore, when the mounting member 20 is inserted into the opening 101, there is no need to align a specific installation direction; installation in any orientation can achieve wedge-shaped fitting of the mating surface 21 with the stop surface 31 and the inclined surface 121, thereby improving assembly efficiency.

In some embodiments, the mounting member 20 is detachably connected with a connecting member 22. The connecting member 22 extends in the insertion direction Z of the mounting member 20 and is used for detachably connecting the camera.

For example, the connecting member 22 is a screw rod. The screw rod penetrates from the side of the mounting member 20 facing the base 10 and is threadedly connected to the mounting member 20. The portion of the screw rod extending out of the mounting member 20 is used for threadedly connecting to a screw hole on the camera.

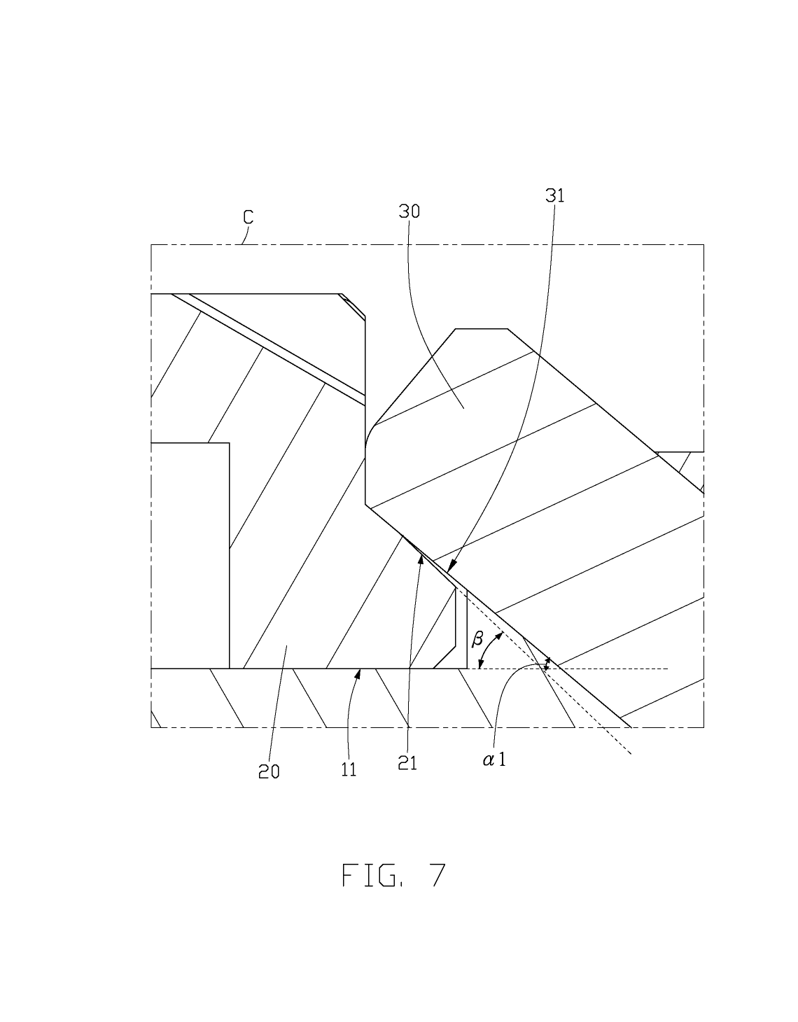

Please refer to FIG. 5 and FIG. 7. In some embodiments, α2=β, so that the inclined surface 121 and the mating surface 21 can fully fit each other, increasing the contact area, making the locking force distribution of the inclined surface 121 on the mating surface 21 uniform, reducing local stress concentration, and improving the reliability of repeated positioning of the mounting member 20 by the inclined surface 121.

In other embodiments, α1=α2, so that the locking forces applied by the inclined surface 121 and the stop surface 31 to the mounting member 20 are symmetrically distributed in magnitude and direction, making the mounting member 20 evenly stressed and improving the symmetry and stability of the locking force.

In some embodiments, α1, α2 and β can be any angle between 0° and 90°, for example 0°, 15°, 30°, 45°, 60°, 75° or 89°. The larger α1 is, the greater the vertical locking force generated by the stop surface 31 on the mounting member 20. Similarly, the larger α2 is, the greater the vertical constraining force generated by the inclined surface 121 on the mounting member 20. The smaller the angle difference between β and α1, the larger the contact area between the mating surface 21 and the stop surface 31, and the more uniform the locking force distribution of the stop surface 31, which can reduce stress concentration.

In some embodiments, the angle β is configured to be 45°. 40°<α1<45°. For example, the angle α1 is configured to be 43° and the angle α2 is configured to be 45°.

The horizontal locking force and the vertical locking force applied by the lock member 30 to the mounting member 20 are close in value, so that the mounting member 20 is evenly stressed and the stability of the locked mounting member 20 is improved. The slight angle deviation between β and α1 provides necessary compensation margin for part machining errors and assembly tolerances to ensure that the stop surface 31 can apply locking force to the mating surface; at the same time, the small difference between β and α1 can maximize the contact area between the mating surface 21 and the stop surface 31 and reduce local stress concentration.

In the quick release mounting assembly 100 described above, when no external force is applied to the operating member 50, the lock member 30 is located at the locking position. Pressing the mounting member 20 downward causes the first end 30a of the lock member 30 to be pushed by the mounting member 20 and gradually move toward the unlocking position. During this process, the elastic member 40 is elastically compressed under the push of the lock member 30. When the lock member 30 moves to the unlocking position and the mounting member 20 contacts the bearing surface 11, the mounting member 20 is located within the opening 101, meanwhile the lock member 30 is no longer pressed by the mounting member 20, and the rebound of the elastic member 40 drives the lock member 30 to reset to the locking position, thereby locking the mounting member 20 into the opening 101.

When it is necessary to remove the mounting member 20, the operating member 50 is pulled or pressed to move the lock member 30 from the locking position to the unlocking position. Referring to FIG. 6, the mounting member 20 is moved to the right and then upward to take the mounting member 20 out of the opening 101.

It can be understood that if the length dimension of the opening 101 is much larger than the side length dimension of the mounting member 20, after moving the mounting member 20 to the right, the limit bumps 111 do not block the upward movement of the mounting member 20, and the mounting member 20 can be directly taken out upward. If the length dimension of the opening 101 is close to the side length dimension of the mounting member 20, after moving the mounting member 20 to the right, the limit bumps 111 will block the upward movement of the mounting member 20; in this case, the mounting member 20 needs to be tilted appropriately and then moved to the upper right to be taken out. “Right” and “upper right” refer to the directions shown in FIG. 6.

FIG. 1 to FIG. 6 illustrate one embodiment of the operating member 50, wherein the operating member 50 is configured as a pull ring 51 formed by bending a columnar rod. At the second end 30b of the lock member 30, both sides of the lock member 30 are provided with mounting holes 33, and the two ends of the pull ring 51 are respectively inserted into one mounting hole 33, so that the pull ring 51 is clamped to the second end 30b of the lock member 30. The structure is simple and easy to assemble. Pulling the pull ring 51 drives the lock member 30 toward the unlocking position. In addition, the pull ring 51 may also be welded and fixed to the second end 30b.

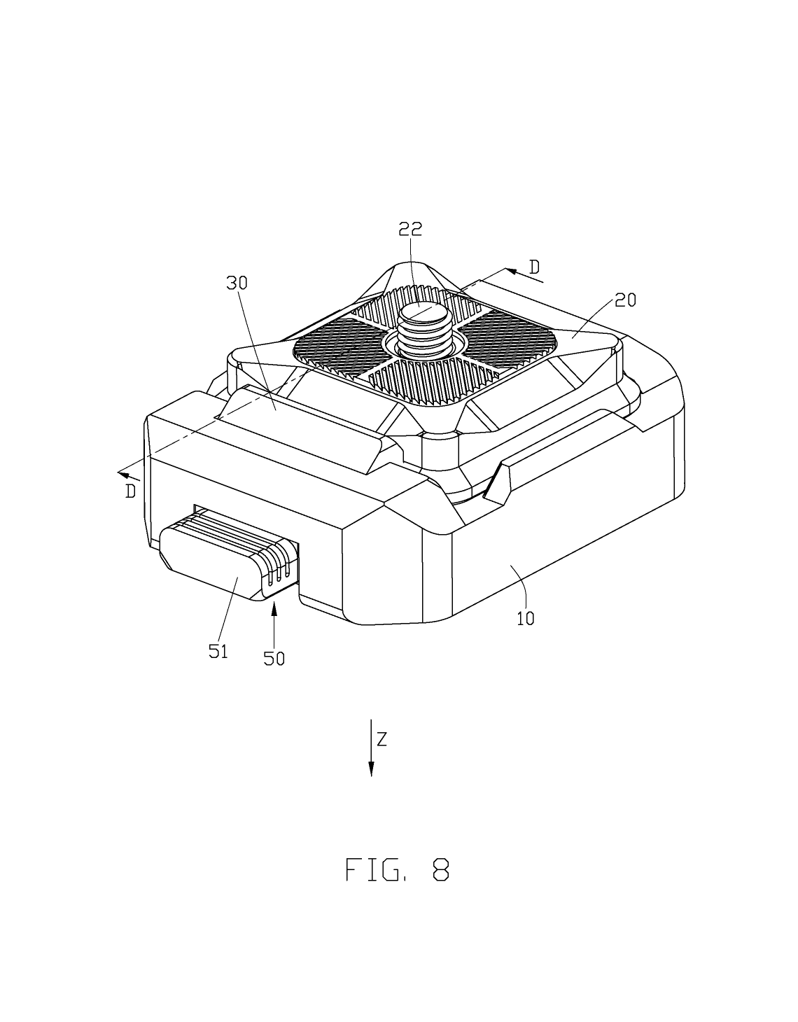

FIG. 8 to FIG. 10 illustrate another embodiment of the operating member 50. The operating member 50 is configured as a holding block 52. The second end 30b of the lock member 30 is provided with a slot 34. One end of the holding block 52 is inserted into the slot 34, and the other end of the holding block extends out of the base 10. Pressing the other end of the holding block 52 drives the lock member 30 toward the unlocking position. For example, the holding block 52 is inserted into the slot 34 in a direction parallel to the bearing surface 11. The structure is simple and easy to assemble, and the holding block 52 and the slot 34 are in an interference fit to prevent accidental loosening of the holding block 52. In addition, the lock member 30 may also be welded and fixed to the second end 30b.

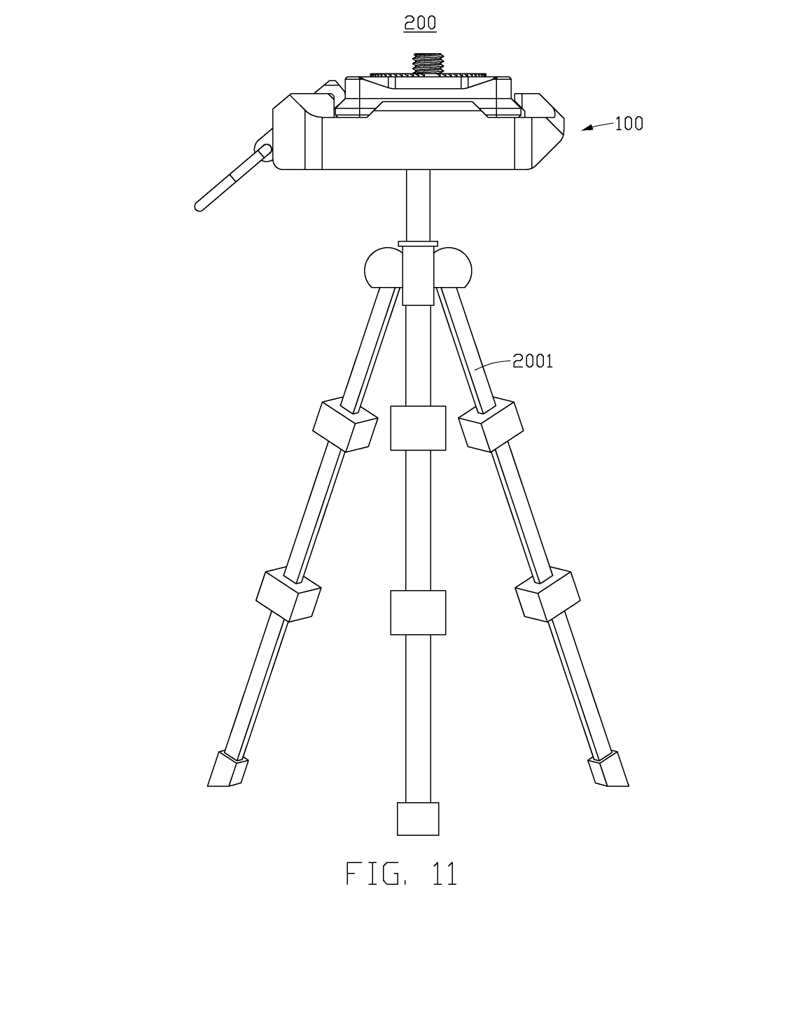

Please refer to FIG. 11. The present application further provides a bracket 200 for camera. The bracket 200 includes a main body 2001 and the quick release mounting assembly 100. The main body 2001 is connected to the quick release mounting assembly 100 and provides support for the quick release mounting assembly 100. The main body 2001 can be a tripod, a monopod, a mobile phone bracket, and the like.

It can be understood that the main body 2001 can be mounted on a supporting plane (e.g., ground or desktop), the base 10 is fixedly connected to the main body 2001, the mounting member 20 is connected to the camera, and by attaching/detaching the mounting member 20 to/from the base 10, the camera can be fixed to or separated from the main body 2001.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A quick release mounting assembly comprising: a base comprising a bearing surface and a periphery limit, and an opening defined by the bearing surface and the periphery limit, a mounting member insertable into the opening and configured for mounting on a camera, and a lock member located on the base and movable between a locking position and an unlocking position relative to the base, and wherein in a case that the lock member moves towards the locking position, the lock member pushes the mounting member against the periphery limit and presses the mounting member on the bearing surface to position the mounting member and the camera; in a case that the lock member moves towards the unlocking position, the lock member releases the mounting member and the mounting member is detachable from the opening.

2. The quick release mounting assembly of claim 1, wherein the lock member comprises a stop surface, and an acute angle α1 is formed between the stop surface and the bearing surface, in the case that the lock member moves towards the locking position, the stop surface pushes and presses the mounting member.

3. The quick release mounting assembly of claim 2, wherein the mounting member comprises a mating surface, the mating surface is configured for abutting the stop surface, an acute angle β is formed between the mating surface and the bearing surface, and α1 < β.

4. The quick release mounting assembly of claim 1, wherein the periphery limit comprises a inclined surface, an acute angle α2 is formed between the inclined surface and the bearing surface; in the case that the lock member moves towards the locking position, the inclined surface and the lock member respectively abut opposite sides of the mounting member to limit the mounting member in the opening.

5. The quick release mounting assembly of claim 4, wherein the periphery limit further comprises two vertical surfaces, the two vertical surfaces are oppositely arranged and located on opposite sides of the inclined surface, the two vertical surfaces are perpendicular to the bearing surface.

6. The quick release mounting assembly of claim 1 further comprising an elastic member connecting the base and the lock member and configured for pushing the lock member towards the locking position.

7. The quick release mounting assembly of claim 6, wherein the bearing surface comprises a slide groove extending through the base, a supporting surface is formed in the slide groove; the lock member is slidably disposed in the slide groove, the lock member comprises a first end and a second end and a protrusion extending from a side of the first end, wherein the protrusion and the supporting surface respectively abut opposite ends of the elastic member; in the case that the lock member moves towards the locking position, the first end extends out of the bearing surface into the opening and pushes the mounting member; in the case that the lock member moves towards the unlocking position, the first end exits the opening and the second end extends out of the slide groove.

8. The quick release mounting assembly of claim 7 further comprising an operating member, wherein the operating member is mounted on the second end and is configured for driving the lock member towards the unlocking position; in the case that the lock member moves towards the locking position, the operating member abuts against the base.

9. The quick release mounting assembly of claim 8, wherein the lock member comprises a mounting hole on the second end, the operating member is configured as a pull ring, two ends of the pull ring are inserted into the mounting hole on opposite sides of the lock member; or wherein the lock member comprises a slot on the second end, the operating member is configured as a holding block, the holding block is inserted into the slot and extends out of the base.

10. The quick release mounting assembly of claim 1, wherein the base comprises a plurality of limit bumps on the bearing surface, the opening is jointly enclosed by the bearing surface and the plurality of limit bumps, the plurality of limit bumps extend along an edge of the bearing surface, the periphery limit is formed on the limit bump, and each two adjacent limit bumps are spaced apart to form a gap.

11. A bracket configured for camera comprising: a main body, and a quick release mounting assembly connected to the main body, the quick release mounting assembly comprising: a base comprising a bearing surface and a periphery limit, and an opening defined by the bearing surface and the periphery limit,a mounting member insertable into the opening and configured for mounting on a camera, and a lock member located on the base and movable between a locking position and an unlocking position relative to the base, and wherein in a case that the lock member moves towards the locking position, the lock member pushes the mounting member against the periphery limit and presses the mounting member on the bearing surface to position the mounting member and the camera; in a case that the lock member moves towards the unlocking position, the lock member releases the mounting member and the mounting member is detachable from the opening.

12. The bracket of claim 11, wherein the lock member comprises a stop surface, and an acute angle α1 is formed between the stop surface and the bearing surface, in the case that the lock member moves towards the locking position, the stop surface pushes and presses the mounting member.

13. The bracket of claim 12, wherein the mounting member comprises a mating surface, the mating surface is configured for abutting the stop surface, an acute angle β is formed between the mating surface and the bearing surface, and α1 < β.

14. The bracket of claim 11, wherein the periphery limit comprises a inclined surface, an acute angle α2 is formed between the inclined surface and the bearing surface; in the case that the lock member moves towards the locking position, the inclined surface and the lock member respectively abut opposite sides of the mounting member to limit the mounting member in the opening.

15. The bracket of claim 14, wherein the periphery limit further comprises two vertical surfaces, the two vertical surfaces are oppositely arranged and located on opposite sides of the inclined surface, the two vertical surfaces are perpendicular to the bearing surface.

16. The bracket of claim 11, wherein the quick release mounting assembly further comprises an elastic member connecting the base and the lock member, and the elastic member is configured for pushing the lock member towards the locking position.

17. The bracket of claim 16, wherein the bearing surface comprises a slide groove extending through the base, a supporting surface is formed in the slide groove; the lock member is slidably disposed in the slide groove, the lock member comprises a first end and a second end, and a protrusion extending from a side of the first end, wherein the protrusion and the supporting surface respectively abut opposite ends of the elastic member; in the case that the lock member moves towards the locking position, the first end extends out of the bearing surface into the opening and pushes the mounting member; in the case that the lock member moves towards the unlocking position, the first end exits the opening and the second end extends out of the slide groove.

18. The bracket of claim 17, wherein the quick release mounting assembly further comprises an operating member, the operating member is mounted on the second end and is configured for driving the lock member towards the unlocking position; in the case that the lock member moves towards the locking position, the operating member abuts against the base.

19. The bracket of claim 18, wherein the lock member comprises a mounting hole on the second end, the operating member is configured as a pull ring, two ends of the pull ring are inserted into the mounting hole on opposite sides of the lock member; or wherein the lock member comprises a slot on the second end, the operating member is configured as a holding block, the holding block is inserted into the slot and extends out of the base.

20. The bracket of claim 11, wherein the base comprises a plurality of limit bumps on the bearing surface, the opening is jointly enclosed by the bearing surface and the plurality of limit bumps, the plurality of limit bumps extend along an edge of the bearing surface, the periphery limit is formed on the limit bump, and each two adjacent limit bumps are spaced apart to form a gap.
